(19) United States
(12) Patent Application Publication
(10) Pub. No.: US 2003/0099808 A1
(43) Pub. Date: May 29, 2003

(54) Method for producing low birefringence, low stress plastic film or sheet with low molecular weight plastic

(75) Inventors: Dennis Joseph Coyle, Clifton Park, NY (US); Kevin P. Capaldo, Mt. Vernon, IN (US)

Correspondence Address: Robert E. Walter, GE Plastics, One Plastics Avenue, Pittsfield, MA, 01201, US

(73) Assignee: General Electric Company

(21) Appl. No.: 10/217,866

(22) Filed: Aug. 13, 2002

Related U.S. Application Data
(60) Provisional application No. 60/333,565, filed on Nov. 27, 2001.

(51) Int. Cl. B32B 3/02

(52) U.S. Cl. 428/64.4; 428/66.6

(57) ABSTRACT

A process for producing low birefringence and low stress thermoplastic polycarbonate film having a birefringence of less than about 20 nm from polycarbonate resin. The process consists of feeding a polycarbonate resin to an extruder, melting the polycarbonate resin, extruding the melted polycarbonate resin downwardly through an extrusion nozzle having the configuration of, forming a continuous film of melted resin, advancing the melted resin downwardly by essentially gravity into a gap between two calendering rolls which lie in a plane essentially perpendicular to the downward extrusion of the resin, cooling the polycarbonate film to below its glass transition temperature and advancing the cooled polymer to storage. The calendering rolls lie in a plane essentially perpendicular to the downward extrusion of the melted resin to wherein one roll is in a plane at an angle of about 30° from said perpendicular. The film is useful for optical media applications.

### CROSS-REFERENCE TO RELATED APPLICATIONS

This application is related to and claims priority from Provisional Application No. 60/333,565 filed on Nov. 27, 2001, the entire contents of which are incorporated by reference herein.

### BACKGROUND OF THE INVENTION

The invention relates to a process for producing low birefringence, low stress transparent thermoplastic film or sheet using low molecular weight thermoplastic resin. The transparent thermoplastic film or sheet prepared by the process of this invention is suitable for optical media applications such as compact discs (CD), digital video disc (DVD), liquid crystal displays (LCD) or any other optical media applications which require a transparent substrate having low birefringence, low stress and having at least one polished surface with minimal surface roughness.

Currently polycarbonate is used as the polymeric material for producing such optical media applications and are made by injection molding. The process is relatively slow and expensive with one injection molding machine typically producing 1 or 2 discs every 3-5 seconds. While this seems relatively fast, it is actually slow and expensive. In addition, it is difficult to produce discs in the future with very low birefringence which will be required to reach higher data densities. Typical CD's have a retardation value (birefringence times thickness) of about 25-30 nm (namometers). Stress and thus birefringence is inherent in injection molding because the melt is solidifying on the walls as the mold is filled, and then additional material is forced into the cavity to compensate for shrinkage as the disc solidifies.

Birefringence is defined as the difference between the refractive indices along two perpendicular directions as measured with polarized light along these directions. It results from molecular orientation, and the measurement of birefringence is the most common method of characterising polymer orientation. It is determined by measurement of the retardation distance by either a compensation or a transmission method. Positive birefringence results when the principal optic axis lies along the chain; negative birefringence when transverse to the chain. In Cartesian coordinates there are three birefringences, two being independent. Thus Δxy=nₓ−n_{y}, the differences in refractive indices along the x and y axes. Uniaxial orientation only requires one of these to describe the orientation. Therefore, in order to obtain a uniform homogeneous polycarbonate, the lower the birefringence (the differences between the refractive indices) the more homogeneous the polymer composition of the product and thus the more uniform properties of the product. This is critical, particular in CD's, DVD's or LCD wherein the laser read out must have minimal or zero distortion. The lower birefringence, the less is the variation in polymer homogeninity and laser distortion.

Improvements in optical data storage media, including increased data storage density, are highly desirable, and achievement of such improvements is expected to improve well established and new computer technology such as read only ROM, write once, rewritable, digital versatile and magneto-optical (MO) disks.

In the case of CD-ROM technology, the information to be read is imprinted directly into a moldable, transparent plastic material, such as bisphenol A (BPA) polycarbonate. The information is stored in the form of shallow pits embossed in a polymer surface. The surface is coated with a reflective metallic film, and the digital information, represented by the position and length of the pits, is read optically with a focused low power (5 mW) laser beam. The user can only extract information (digital data) from the disk without changing or adding any data. Thus, it is possible to “read” but not to “write” or “erase” information.

The operating principle is a write once read many (WORM) drive is to use a focused laser beam (20-40 mW) to make a permanent mark on a thin film on a disk. The information is then read out as a change in the optical properties of the disk, e.g., reflectivity or absorbance. These changes can take various forms such as, “hole burning” which is the removal of material, typically a thin film of tellurium, by evaporation, melting or spalling (sometimes referred to as laser ablation), or bubble, or pit formation involves deformation of the surface, usually of a polymer overcoat of a metal reflector.

Although the CD-ROM and WORM formats have been successfully developed and are well suited for particular applications, the computer industry is focusing on erasable media for optical storage (EODs). There are two types of EODs: phase change (PC) and magneto-optic (MO).

Generally, amorphous materials are used for MO storage and have a distinct advantage in MO storage as they do not suffer from “grain noise”, spurious variations in the plane of polarization of reflected light caused by randomness in the orientation of grains in a polycrystalline film. Bits are written by heating above the Curie point, T_{c}, and cooling in the presence of a magnetic field, a process known as thermomagnetic writing. In the phase-change material, information is stored in regions that are different phases, typically amorphous and crystalline. The film is initially crystallized by heating it above the crystallization temperature. In most of these materials, the crystallization temperature is close to the glass transition temperature. When the film is heated with a short, high power focused laser pulse, the film can be melted and quenched to the amorphous state. The amorphized spot can represent a digital “1” or a bit of information. The information is read by scanning it with the same laser, set at a lower power, and monitoring the reflectivity.

In the case of WORM and EOD technology, the recording layer is separated from the environment by a transparent, non-interfering shielding layer. Materials selected for such “read through” optical data storage applications must have outstanding physical properties, such as moldability, ductility, a level of robustness compatible with particular use, resistance to deformation when exposed to high heat or high humidity, either alone or in combination. The materials should also interfere minimally with the passage of laser light through the medium when information is being retrieved from or added to the storage device.

As data storage densities are increased in optical data storage media to accommodate newer technologies, such as DVD and higher density data disks for short or long term data archives, the design requirements for the transparent plastic component of the optical data storage devices have become increasingly stringent. Materials displaying lower birefringence at current, and in the future progressively shorter “reading and writing” wavelengths have been the object of intense efforts in the field of optical data storage devices.

Birefringence in an article molded from polymeric material is related to orientation and deformation of its constituent polymer chains. Birefringence has several sources, including the structure and physical properties of the polymer material, the degree of molecular orientation in the polymer material and thermal stresses in the processed polymer material. For example, the birefringence of a molded optical article is determined, in part, by the molecular structure of its constituent polymer and the processing conditions, such as the forces applied during mold filling and cooling, used in its fabrication which can create thermal stresses and orientation of the polymer chains.

The observed birefringence of a disk is therefore determined by the molecular structure, which determines the intrinsic birefringence, and the processing conditions, which can create thermal stresses and orientation of the polymer chains. Specifically, the observed birefringence is typically a function of the intrinsic birefringence and the birefringence introduced upon molding articles, such as optical disks. The observed birefringence of an optical disk is typically quantified using a measurement termed “in-plane birefringence” or IBR, which is described more fully below.

For a molded optical disk, the IBR is defined as:

IBR=(nᵣ−n_{θ})d=Δn_{rθ}d(3)

where nᵣ and n_{θ} are the refractive indices along the r and θ cylindrical axes of the disk; nᵣ is the index of refraction seen by a light beam polarized along the radial direction, and n_{θ} is the index of refraction for light polarized azimuthally to the plane of the disk. The thickness of the disk is given by d. The IBR governs the defocusing margin, and reduction of IBR will lead to the alleviation of problems which are not correctable mechanically. IBR is a property of the finished optical disk. It is formally called a “retardation” and has units of nanometers.

In applications requiring higher storage density, such as DVD recordable and rewritable material, the properties of low birefringence and low water absorption in the polymer material from which the optical article is fabricated become even more critical. In order to achieve higher data storage density, low birefringence is necessary so as to minimally interfere with the laser beam as it passes through the optical article, for example a compact disk.

Materials for DVD recordable and rewritable material require low in-plane birefringence, in particular preferably less than about ±40 nm single pass; excellent replication of the grooved structure, in particular greater than about 90% of stamper.

The great economic advantage of producing optical media at a faster rate via a continuous film extrusion process whereby a continuous plastic film or sheet of 4-8 feet wide could be produced at speeds of 10-60 feet/minute from which discs could be cut out is certainly desired. Extrusion casting, where a melt is extruded through a slot die and deposited on a polished metal roller to solidify, can produce low birefringence film but the top surface of the film is not smooth enough. Extrusion calendering, whereby a second polished metal roll is added to form a nip or gap to squeeze the plastic on both sides as it solidifies, is widely used to produce very uniform and smooth surface films, but the flow in the nip between rigid rolls induces very high stresses and such films have retardation values of hundreds to thousands of nanometers. A resilient elastomeric cover can be put on one of the rolls to produce textured films that have lower stress, but the texture is unacceptable for optical media applications.

U.S. Pat. No. 3,756,760 teaches the use of a single metal outer sleeve of nickel over a rubber-covered roller to accommodate and smooth the non-uniformity of the extrudate from an extrusion die upon delivering melt to the calendering nip. It does not disclose how to use this to control stress in the film and birefringence. In addition, such a sleeve is too fragile to be of practical use.

U.S. Pat. No. 5,076,987 discloses producing optical quality extrusion film by calendering the film between a ground elastic roller and a high gloss steel roller or between a lacquered elastic roller and a high gloss steel roller or between a ground elastic roller and a high gloss steel roller to produce a film having a high gloss surface and a matte surface or coating the matte surface, or producing a film having a high gloss on both surfaces.

U.S. Pat. No. 5,149,481 discloses extruding a sheet or film into the roll gap of a smoothed upper roll and a lower roll wherein the temperature of the upper roll is below the glass transition temperature of the plastic and the lower roll is maintained at a temperature in the plastic state domain of the plastic sheet or film.

U.S. Pat. No. 5,242,742 is similar to U.S. Pat. No. 5,149,481 except that it discloses a sheet of film having a birefringence of less than 50 nm and preferably less than 20 nm, wherein one surface is cooled to below the glass transition temperature while the other surface is maintained in the thermoplastic state.

U.S. Pat. No. 4,925,379 discloses a process for producing a plastic sheet, wherein at least one layer is a polyurethane layer, by extrusion and pressing at a temperature higher than the softening point of the polyurethane.

U.S. Pat. No. 5,286,436 is a division of U.S. Pat. No. 5,242,742 and discloses producing a thermoplastic strip having a birefringence equal to or less than 50 nm, wherein one surface is cooled to below the glass transition temperature and the other surface is maintained in the thermoplastic state and then cooling the thermoplastic strip.

### SUMMARY OF THE INVENTION

An important feature of the process of this instant invention is the ability to produce polycarbonate film having a low birefringence of 20 nm or less for optical media applications. Polycarbonates having a molecular weight of 30,000 weight average or less and preferably 25,000 or less are most desirable for optical media applications since they have a shorter relaxation time and therefore lower stress and lower birefringence under the same processing conditions. Another important feature of the process of the instant invention is to produce a polycarbonate film having a birefringence of 20 nm or less. These features are achieved by the downward extrusion of the polycarbonate resin. To prepare high molecular weight polycarbonate film for optical media applications by injection molding is unacceptable since it produces film having a high birefringence in excess of 50 nm. Low molecular weight polycarbonates are not suitable in conventional extrusion due to its low molecular weight and thus low intrinsic viscosity (IV). Heretofore, such polycarbonates resins have been only suitable for optical media applications by injection molding.

It has been surprisingly discovered that polycarbonate film or sheet can be prepared quickly and economically by downward extruding molten polycarbonate resin into the nip or gap between highly polished chrome-surfaced rolls, particularly polycarbonate resin having low melt strength, low viscosity such as low molecular weight polycarbonate resins. The surprising discovery is that low birefringencent polycarbonate resin film can be produced by downward extrusion of the polycarbonate resin without controls on the film extrudate as it leaves the die orifice. Prior art has shown that controls are employed to control bead height along the nip of the inlet side of a pair of calendering in order to obtain uniform birefringence across the width of the plastic. The birefringence obtained by the prior art was 50 nm±10% for a film thickness of 500 nm. In the practice of the invention of this application, it was found that controls were not needed to obtain polycarbonate film having a retardation of 20 nm or less at thickness of 100-600 μm. This was totally unexpected.

The calendering rolls of this invention are generally in a horizontal plane but may lie in a plane at any angle of up to about 30° from the horizontal (note FIG. 2). Preferably the calendering rolls are in a horizontal plane essentially perpendicular to the plane of the downward extruding molten resin. As used herein, the terms film and sheet are used interchangeable and refer to the thermoplastic material having a final thickness of about 0.005 to about 0.060 inches but may be thicker depending on the final application.

### BRIEF DESCRIPTION OF THE DRAWINGS

FIG. 1 is a schematic view of the continuous extrusion system of this invention illustrating the extrusion of a thermoplastic melt downward into the nip or gap between two calendering rolls lying in a horizontal plane.

FIG. 2. Is a schematic view of another configuration wherein the calendering rolls lie in a plane at an angle of 30° from the horizontal.

### DETAILED DESCRIPTION OF THE INVENTION

The present invention discloses a process, a product and an extrusion system for preparing thermoplastic film or sheet for optical media applications from polycarbonate resin wherein the product has low birefringence of 20 μm or less, low stress and with at least one surface having a roughness of less than about 4 microinches and preferably about 0.5 to about 2.0 microinches. The process comprises of the steps feeding a polycarbonate resin to an extruder, melting the resin to above its glass transition temperature (Tg) while advancing it through the extruder, extruding downwardly the molten resin through the orifice of an extrusion nozzle into the nip or gap between two highly polished calendering rolls, cooling the thermoplastic film or sheet to below its glass transition temperature (Tg) and storing the cooled film or sheet for further use in optical media application. Low molecular weight polycarbonate resin means polycarbonate resin having a weight average molecular weight of less than about 25,000 and preferably about 13,000 to less than about 25,000 and more particularly 13,000 to less than 20,000. As stated previously, these polycarbonate resins are generally regarded as being unsuitable for conventional extrusion.

At least one calendering roll has a highly polished surface so as to provide a thermoplastic film or sheet with a surface having a surface roughness of less than about 4 microinches. However, both calendering rolls may be highly polished to provide both surfaces of the film or sheet with a highly polished surface. Preferably the polished calendering roll is chrome or chromeum plated which are used interchangeably to describe the chromium surface calendering roll. However, other calendering rolls may be employed provided they provide film having a highly polished surface.

The thermoplastic polycarbonate resin that may be employed in producing the polycarbonate film of this invention, includes without limitation, aromatic polycarbonates, copolymers of an aromatic polycarbonate such as polyester carbonate copolymer, blends thereof, and blends thereof with other polymers depending on the end use application. Preferably the thermoplastic polycarbonate resin is an aromatic homo-polycarbonate resin and examples of such polycarbonate resins are described in U.S. Pat. No. 4,351,920 which is incorporated herein by reference. They are obtained by the reaction of an aromatic dihydroxy compound with a carbonyl chloride. Other polycarbonate resins may be obtained by the reaction of an aromatic dihydroxy compound with a carbonate precursor such as a diaryl carbonate. A preferred aromatic dihydroxy compound is 2,2-bis(4-hydroxy phenyl) propane (i.e. Bisphenol-A). A polyester carbonate coplymer is obtained by the reaction of a dihydroxy phenol, a carbonate precursor and dicarboxylic acid such as terephthalic acid or isophthalic acid or a mixture of terephthalic and isophthalic acid. Optionally, an amount of a glycol may also be used as a reactant.

The film produced by the practice of the invention may be transparent or translucent and are used interchangeably. Transparent shall include in its meaning “transparent” and “translucent”. Therefore the film produced in accordance with the practice of this invention has low birefringence, low stress and is highly polished on at least one surface thereof. The birefringence of the film produced by the practice of this invention is less than about 20 nm, and more particularly is less than about 15 nm. The surface of the highly polished thermoplastic film is less than about 4 microinches in roughness and preferably about 0.5 to about 2.0 microinchs in roughness. The film also has less than 1% haze.

The process of producing the film of this invention comprises feeding a polycarbonate resin to a screw extruder, heating the resin to above its glass transition temperature (Tg) thereby producing a viscous melt of the polycarbonate resin, extruding downwardly the viscous thermoplastic melt under pressure through the orifice of an extrusion nozzle which orifice is generally a slot, forming a continuous film of molten thermoplastic resin (extrudate), passing the extrudate through the nip or gap of a pair of a calendering rolls which essentially lie in a horizontal plane essentially perpendicular to the downward extrusion of the polycarbonate film to form the finished film.

While the calendering rolls are shown in a horizontal plane essentially perpendicular to the downward extrusion of the thermoplastic resin, the calendering rolls may lie in a horizontal plane or in a plane at any angle of from 0° (horizontal) up to about 30° from the horizontal. An important feature of this invention lies in the downward extrusion of the carbonate polymer into the nip or gap between a pair of calendering rolls at least one of which has a highly polished surface.

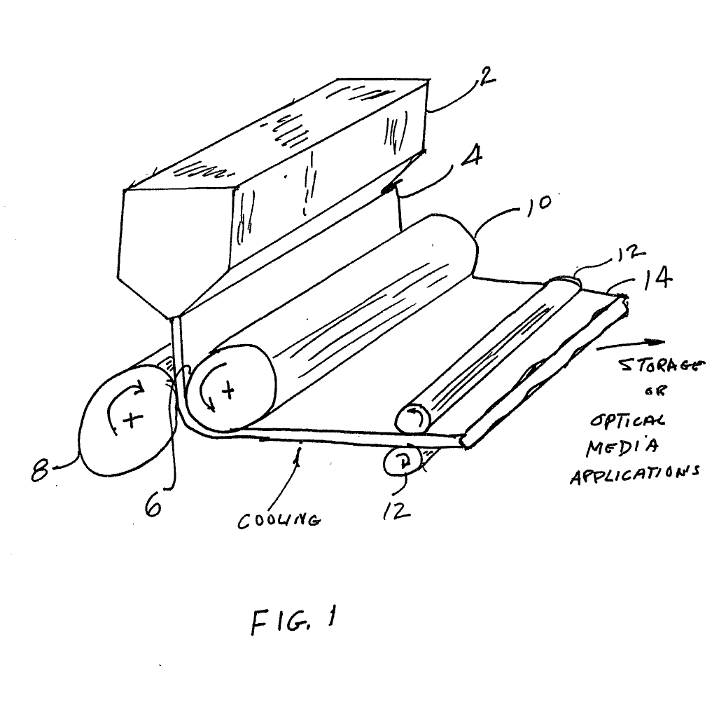

FIG. 1 is a schematic drawing of the continuous process of this invention and the apparatus employed herein illustrating extrusion nozzle 2 through which polycarbonate resin 4 is extruded. The polycarbonate resin is heated to a temperature sufficient to melt polycarbonate resin 4 which temperature is above the glass transition temperature (Tg) of the polycarbonate resin. The extruded melt 4 is passed through nip or gap 6 formed by calendering rolls 8 and 10, is cooled and then passed through pull rolls 12. The cooled finished film 14, having low birefringence, low stress and a highly polished surface, is employed in optical media applications.

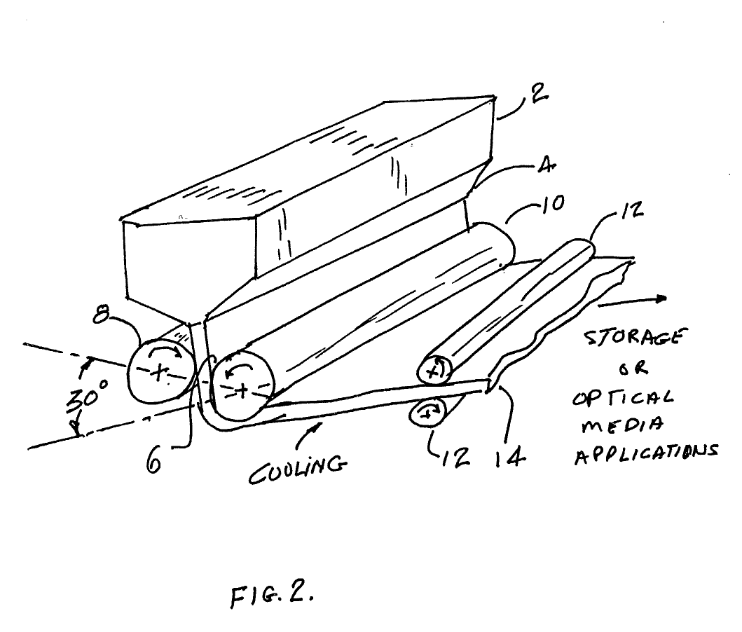

FIG. 2 is a schematic illustration of another embodiment of this invention showing extrusion nozzle 2, nip or gap 6 formed between calendering rolls 8 and 10, cooling film 4, pull rolls 12, cooled finished film 14 is sent to storage or used in optical media applications. However, in schematic drawing FIG. 2, finishing rolls 14 and 16 are in a plane at an angle of 30° from the horizontal.

The following example is provided merely to show one skilled in the art how to apply the principals of this invention as discussed herein. This example is not intended to limit the scope of the claims appended to this invention.

### EXAMPLES

Extrusion trials were conducted on a horizontal first nip roll stack, producing film of various thicknesses and approximately 5 ft. wide. The plastic was polycarbonate of various molecular weights and melt temperatures.

The results obtained at the various thicknesses, melt temperatures and molecular weights (weight average) are reported in Table I below.

TABLE I

| | Film | Molecular | Melt | |
|---|---|---|---|---|
| Example | Thickness | Weight | Temperature | Retardation |
| 1 | 0.024 | 30,000 | 595 | 15 |
| 2 | 0.024 | 18,000 | 520 | 12 |
| 3 | 0.010 | 30,000 | 611 | 13 |
| 4 | 0.010 | 18,000 | 525 | 14 |
| 5 | 0.020 | 30,000 | 615 | 19 |
| 6 | 0.012 | 30,000 | 615 | 16 |
| 7 | 0.008 | 30,000 | 615 | 20 |

Although the present invention has been described in detail, it should be understood that various modifications, substitutions, or alterations can be made without departing from the intended scope as defined in the appended claims.

What is claimed:

1. An extrusion process for producing a continuous thermoplastic polycarbonate resin film having low birefringence of about 20 nm or less, low stress and a surface roughness of less than about 4 microinches on at least one surface, said process comprising the steps of feeding a thermoplastic polycarbonate resin to an extruder, heating the resin in the extruder to above its glass transition temperature thereby producing a viscous melt of the thermoplastic polycarbonate resin, extruding the melted resin downwardly through an extrusion nozzle orifice having a slot configuration, forming a continuous thermoplastic polycarbonate resin film of low birefringence, passing the melted polycarbonate resin film downwardly into a gap between two calendering rolls at least one of which has a highly polished surface, advancing the melted polymer film through said gap, cooling the melted polymer film to below its glass transition temperature, and advancing the cooled polymer film to storage; said calendering rolls lie in a plane from essentially perpendicular to the downward extrusion of the melted resin to wherein one roll is in a plane at an angle of about 30° from said perpendicular.

2. The process of claim 1 wherein the thermoplastic resin is a low molecular weight resin having a weight average molecular weight of less than about 25,000.

3. The process of claim 1 wherein the thermoplastic resin has a weight average molecular weight of less than 20,000.

4. The process of claim 2 wherein the weight average molecular weight is about 13,000 to less than 25,000.

5. The process of claim 1 wherein the cooled thermoplastic film has a thickness of about 100 μm to about 600 μm.

6. The process of claim 1 wherein calendering rolls have highly polished surfaces.

7. The process of claim 1 wherein both surfaces of the cooled film have a roughness of less than about 4 microinches.

8. The process of claim 1 wherein the polycarbonate resin is a bisphenol-A polycarbonate.

9. The process of claim 1 wherein the stored polycarbonate film is further used to produce optical grade articles.

10. A polycarbonate film having a birefringence of 20 nm or less and low stress prepared by the process of claim 1.

11. A low molecular weight polycarbonate film having a weight average molecular weight of less than about 25,000, prepared by the process of claim 2.

12. An optical compact disc having a transparent polycarbonate resin substrate which has a birefringence of 20 nm or less.

13. An optical compact disc having a transparent polycarbonate resin substrate wherein the polycarbonate has a weight average molecular weight of less than about 25,000.
